(19) United States
(12) Patent Application Publication
(10) Pub. No.: US 2015/0149251 A1
(43) Pub. Date: May 28, 2015

(54) METHOD AND SYSTEM FOR INTEGRATING PHONE NUMBERS WITH TRANSACTION DATA

(71) Applicant: MasterCard International Incorporated, Purchase, NY (US)

(72) Inventors: Kenny UNSER, Fairfield, CT (US); Serge Bernard, Danbury, CT (US); Nikhil Malgatti, Stamford, CT (US)

(73) Assignee: MasterCard International Incorporated, Purchase, NY (US)

(21) Appl. No.: 14/088,050

(22) Filed: Nov. 22, 2013

(51) Int. Cl. G06Q 30/02; G06Q 40/00

(52) U.S. Cl. CPC G06Q 30/0204; G06Q 40/12
USPC 705/7.33

(57) ABSTRACT

A method for linking phone data to transaction history includes: storing, in a database, a plurality of consumer profiles, wherein each consumer profile includes data related to a consumer including at least a plurality of consumer characteristics and plurality of transaction data entries, each transaction data entry corresponding to a payment transaction involving the related consumer; receiving, by a receiving device, a phone profile, wherein the phone profile includes at least a phone number associated with a specific consumer and a plurality of demographic characteristics associated with the specific consumer; identifying, by a processing device, at least one consumer profile of the plurality of consumer profiles where at least a predefined number of the included plurality of consumer characteristics correspond to the plurality of demographic characteristics; and associating, in the database, each of the identified at least one consumer profile with the phone number included in the received phone profile.

### FIELD

The present disclosure relates to the linking of phone numbers to transaction history, specifically the linking of consumer phone number information with consumer transaction history based on a plurality of demographic characteristics.

### BACKGROUND

Transaction data, which may include any useful data captured from a payment transaction, may be useful in a variety of situations. Content providers, such as merchants, retailers, third party offer providers, or advertisers may utilize transaction data to identify targeted content, such as offers and advertisements, to distribute to potential consumers. Transaction data may provide valuable insights as to the potential for a specific consumer to redeem an offer or purchase an advertised product, based on their past transactions. However, in many instances, it may be difficult for an entity to identify the transaction data corresponding to a consumer until after a consumer presents their payment information, which may only occur once a consumer is already transacting. This may be less than ideal for content providers, as they may not be able to identify the consumer until the consumer is already transacting, and thus be unable to influence consumers that may otherwise not transact with them.

Thus, there is a need for a technical solution to identify transaction data corresponding to consumers prior to the point of sale. Some services have been developed where a consumer may sign up for a service in order to receive offers based on their transaction history, effectively identifying themselves for association with their transaction data. However, such systems often require a consumer to seek out such service, register with the service, and supply information. This may result in a low rate of enrollment by consumers, which may leave a large consumer base unavailable for targeting. In addition, such systems often rely solely on transaction data and feedback provided by the consumer themselves.

Thus, there is a need for a technical solution to identify consumers, without requiring consumer participation, and to combine transaction data with additional useful data that may be beneficial.

### SUMMARY

The present disclosure provides a description of systems and methods for linking phone numbers to transaction history and distributing consumer profiles.

A method for linking phone data to transaction history includes: storing, in a database, a plurality of consumer profiles, wherein each consumer profile includes data related to a consumer including at least a plurality of consumer characteristics and a plurality of transaction data entries, each transaction data entry corresponding to a payment transaction involving the related consumer; receiving, by a receiving device, a phone profile, wherein the phone profile includes at least a phone number associated with a specific consumer and a plurality of demographic characteristics associated with the specific consumer; identifying, by a processing device, at least one consumer profile of the plurality of consumer profiles where at least a predefined number of the included plurality of consumer characteristics correspond to the plurality of demographic characteristics; and associating, in the database, each of the identified at least one consumer profile with the phone number included in the received phone profile.

A method for distributing a linked consumer profile includes: storing, in a database, a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer; receiving, by a receiving device, a consumer profile request, wherein the consumer profile request includes at least a specific consumer identifier; identifying, in the database, a specific consumer profile where the included consumer identifier corresponds to the specific consumer identifier; transmitting, by a transmitting device, a request for phone data, wherein the request for phone data includes at least the plurality of consumer characteristics included in the identified specific consumer profile; receiving, by the receiving device, phone data, wherein the phone data includes at least a phone number; including, in the database, the received phone data in the identified specific consumer profile; and transmitting, by the transmitting device, the specific consumer profile including the received phone data in response to the received consumer profile request.

Another method for linking phone data to transaction history includes: storing, in a database, a plurality of consumer profiles, wherein each consumer profile includes data related to one or more consumers including at least a plurality of consumer characteristics corresponding to each of the related one or more consumers, and a plurality of transaction data entries, each transaction data entry corresponding to a payment transaction involving one of the related one or more consumers; receiving, by a receiving device, a consumer profile request including at least phone data related to a specific consumer, wherein the phone data includes at least a phone number; transmitting, by a transmitting device, a characteristic request including at least the phone number; receiving, by the receiving device, a plurality of demographic characteristics in response to the transmitted characteristic request; identifying, in the database, a specific consumer profile where at least a predetermined number of the included plurality of consumer characteristics correspond to the received plurality of demographic characteristics; associating, in the database, the received phone data with the identified specific consumer profile; and transmitting, by the transmitting device, the identified specific consumer profile in response to the received consumer profile request.

A system for linking browsing data to transaction history includes a database, a receiving device, and a processing device. The database is configured to store a plurality of consumer profiles, wherein each consumer profile includes data related to a consumer including at least a plurality of consumer characteristics and a plurality of transaction data entries, each transaction data entry corresponding to a payment transaction involving the related consumer. The receiving device is configured to receive a phone profile, wherein the phone profile includes phone data associated with a specific consumer and a plurality of demographic characteristics associated with the specific consumer. The processing device is configured to: identify at least one consumer profile of the plurality of consumer profiles where at least a predefined number of the included plurality of consumer characteristics correspond to the plurality of demographic characteristics; and associate, in the database, each of the identified at least one consumer profile with the phone data included in the received phone profile.

A system for distributing a linked consumer profile includes a database, a receiving device, a processing device, and a receiving device. The database is configured to store a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer. The receiving device is configured to receive a consumer profile request, wherein the consumer profile request includes at least a specific consumer identifier. The processing device is configured to identify, in the database, a specific consumer profile where the included consumer identifier corresponds to the specific consumer identifier. The transmitting device is configured to transmit a request for phone data, wherein the request for phone data includes at least the plurality of consumer characteristics included in the identified specific consumer profile. The receiving device is further configured to receive phone data. The processing device is further configured to include, in the database, the received phone data in the identified specific consumer profile. The transmitting device is further configured to transmit the specific consumer profile including the received phone data in response to the received consumer profile request.

Another system for linking phone data to transaction history includes a processing device, a database, a receiving device, and a transmitting device. The database is configured to store a plurality of consumer profiles, wherein each consumer profile includes data related to one or more consumers including at least a plurality of consumer characteristics corresponding to each of the related one or more consumers, and a plurality of transaction data entries, each transaction data entry corresponding to a payment transaction involving one of the related one or more consumers. The receiving device is configured to receive a consumer profile request including at least phone data related to a specific consumer, wherein the phone data includes at least a phone number. The transmitting device is configured to transmit a characteristic request including at least the phone number. The receiving device is further configured to receive a plurality of demographic characteristics in response to the transmitted characteristic request. The processing device is configured to: identify, in the database, a specific consumer profile where at least a predetermined number of the included plurality of consumer characteristics correspond to the received plurality of demographic characteristics; and associate, in the database, the received phone data with the identified specific consumer profile. The transmitting device is further configured to transmit the identified specific consumer profile in response to the received consumer profile request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIGS. 1A and 1B are high level architectures illustrating systems for linking consumer phone numbers, transaction history, and demographic characteristics in accordance with exemplary embodiments.

FIG. 2 is a block diagram illustrating the processing server of FIG. 1 for the linking of consumer phone numbers and transaction history in accordance with exemplary embodiments.

FIG. 3 is a flow diagram illustrating a method for linking phone data with transaction history in a consumer profile in accordance with exemplary embodiments.

FIG. 4 is a flow chart illustrating a method for populating and distributing a consumer profile including phone data and transaction history in accordance with exemplary embodiments.

FIG. 5 is a diagram illustrating the linking of consumer phone data to transaction history in accordance with exemplary embodiments.

FIGS. 6A and 6B are a flow diagram illustrating a method for distributing content to a consumer based on linked phone, demographic, and transaction data in accordance with exemplary embodiments.

FIG. 7 is a flow chart illustrating an exemplary method for linking phone data to transaction history in accordance with exemplary embodiments.

FIG. 8 is a flow chart illustrating an exemplary method for distributing a linked consumer profile in accordance with exemplary embodiments.

FIG. 9 is a flow chart illustrating an exemplary method for linking phone and demographic data to transaction history in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems that do not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the systems and methods discussed herein may not possess the PII or be able to decrypt the encrypted PII.

### System for Linking Phone Data to Transaction History

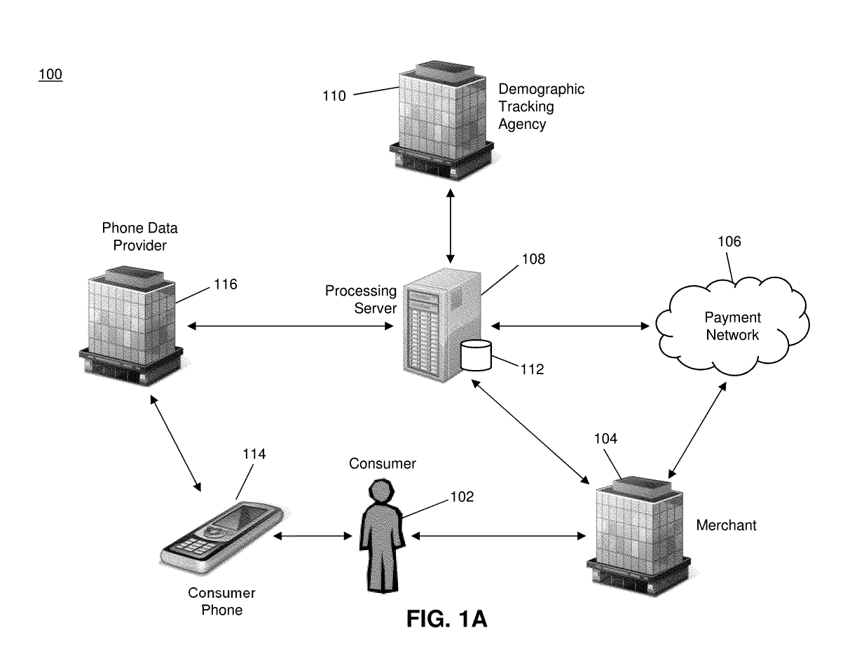

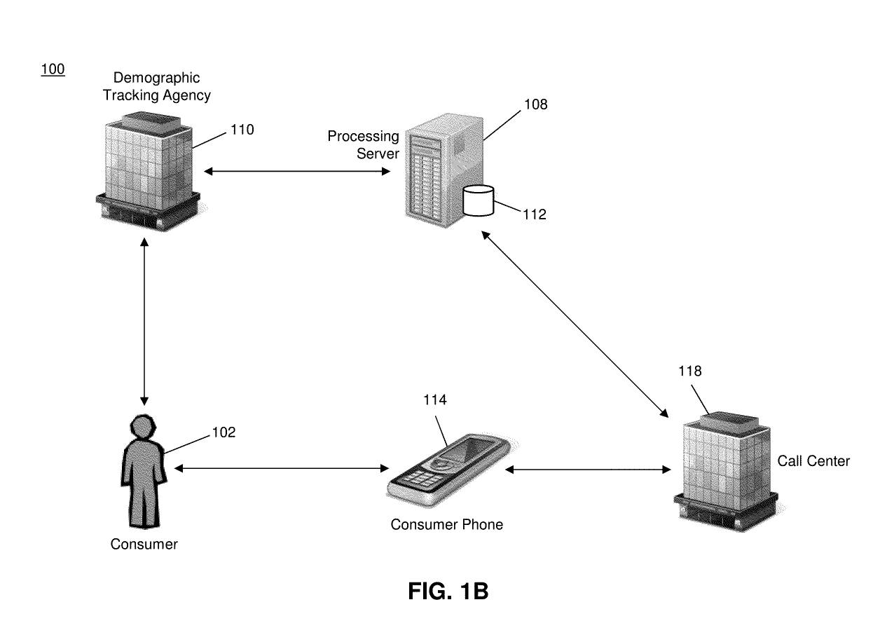

FIG. 1A illustrates a system 100 for linking consumer phone data including a phone number to consumer transaction history.

A consumer 102 may engage in one or more payment transactions at a merchant 104. The payment transaction or transactions may be conducted in person (e.g., at a physical location of the merchant 104), or remotely, such as via the Internet, telephone, by mail, etc. The transaction may be processed via a payment network 106. The payment network 106 may transmit a copy of the authorization request or transaction data included therein to a processing server 108, discussed in more detail below. The processing server 108 may store the transaction data in a consumer profile of a consumer database 112, also discussed in more detail below, associated with the consumer 102. In an exemplary embodiment, the transaction data may only be stored in a consumer profile associated with the particular consumer 102 with the permission of the consumer 102.

The processing server 108 may receive demographic characteristics associated with the consumer 102 from a demographic tracking agency 110 or other third party. The demographic characteristics may include: age, gender, income, marital status, familial status, residential status, occupation, education, zip code, postal code, street address, county, city, state, country, etc. The processing server 108 may store the demographic characteristics in the consumer profile associated with the consumer 102. In an exemplary embodiment, the consumer profile associated with the consumer 102 may not include any personally identifiable information. In some instances, the consumer 102 may be grouped with a plurality of consumers having similar or the same demographic characteristics.

The consumer 102 may possess a consumer phone 114, such as a cellular phone, smart phone, computer with telephone capabilities, etc. The consumer phone 114 may be associated with one or more phone numbers. Data regarding the consumer phone 114, including the associated one or more phone numbers, may be obtained by a phone data provider The phone data provider 116 may be an entity configured to collect phone data, such as a mobile network operator, telecommunication service, etc. The phone data provider 116 may also store demographic characteristic data associated with the consumer 102 associated with each consumer phone 114 for which phone data is stored. For example, a mobile network operator may obtain demographic characteristics of the consumer 102 as part of the registration of the consumer phone 114 to their mobile network.

The phone data provider 116 may be configured to furnish the stored phone data to the processing server 108, which may then store the data in corresponding consumer profiles in the consumer database 112. In some embodiments, the phone data provider 116 may provide phone data to the processing server 108 associated with the demographic characteristics corresponding to the consumer 102 associated with respective phone data. In such an embodiment, the processing server 108 may match the phone data to one or more consumer profiles based on the demographic characteristics and the consumer characteristics of the one or more consumer profiles. In other embodiments, the processing server 108 may transmit demographic characteristics for one or more consumer profiles to the phone data provider 116. The phone data provider 116 may then identify phone data corresponding to the consumer characteristics, and distribute the identified phone data to the processing server 108. The processing server 108 may then store the phone data in the corresponding one or more consumer profiles. Methods for identifying correspondence between demographic characteristics and consumer characteristics are discussed in more detail below. Additional methods for obtaining the phone data for one or more consumers without personally identifying a consumer will be apparent to persons having skill in the relevant art.

The processing server 108 may then have transaction history and phone data for a consumer 102 linked together in a consumer profile associated with the consumer 102. In an exemplary embodiment, the consumer profile may not include any personally identifiable information for the consumer 102, except with the express consent of the consumer 102. By linking transaction history with phone data, the processing server 108, or a third party, such as an advertiser, that may receive the data from the processing server 108, may be able to obtain significantly more data from a consumer's combined phone and transaction history than utilizing either set of data alone.

Another beneficial use of the linking of phone data to transaction history may be illustrated in the alternative embodiment of the system 100 illustrated in FIG. 1B. In the alternative system 100, the consumer 102 may contact a cell center 118 using the consumer phone 114. In some instances, the call center 118 may call the consumer phone 114 associated with the consumer 102.

The call center 118 may wish to provide additional services or content to the consumer 102. In order to better select services or content to provide to the consumer 102, the call center 118 may request detailed information regarding the consumer 102, including demographic characteristics and transaction history. For example, the call center 118 may be associated with a merchant 104 offering consumer goods, and may target products to advertise or offer the consumer 102 based on previous purchase and demographic information of the consumer 102.

The call center 118 may submit a request for data to the processing server 108. The request may include at least the phone number associated with the consumer phone 114. The processing server 108 may then request consumer demographic characteristics (e.g., consumer characteristics) from the demographic tracking agency 110 or other appropriate entity (e.g., the phone data provider 116). The demographic tracking agency 110 may identify consumer characteristics associated with the phone number corresponding to the consumer phone 114, and may forward the identified consumer characteristics to the processing server 108.

The processing server 108 may then, as discussed in more detail below, identify a consumer profile to associate with the consumer phone 114 (e.g., and accordingly, the consumer 102) based on correspondence between the consumer characteristics received from the demographic tracking agency 110 and demographic characteristics included in a consumer profile stored in the consumer database 112. The processing server 108 may then transmit the transaction data included in the identified consumer profile, and the consumer characteristics, to the call center 118. The call center 118 may use the transaction data and consumer characteristics for identifying targeted content or services to provide to the consumer 102 via the consumer phone 114 or other suitable method of communication as will be apparent to persons having skill in the relevant art.

By using commonality in consumer characteristics to identify transaction data to associate with the consumer phone 114, the call center 118 may be able to identify targeted content for the consumer 102 without the use of personally identifiable information. As a result, the privacy of the consumer 102 may be maintained and protected by the call center 118 and the processing server 108, while the consumer 102 may also obtain the benefit of offers or advertisements targeted specially for similar consumers.

### Processing Server

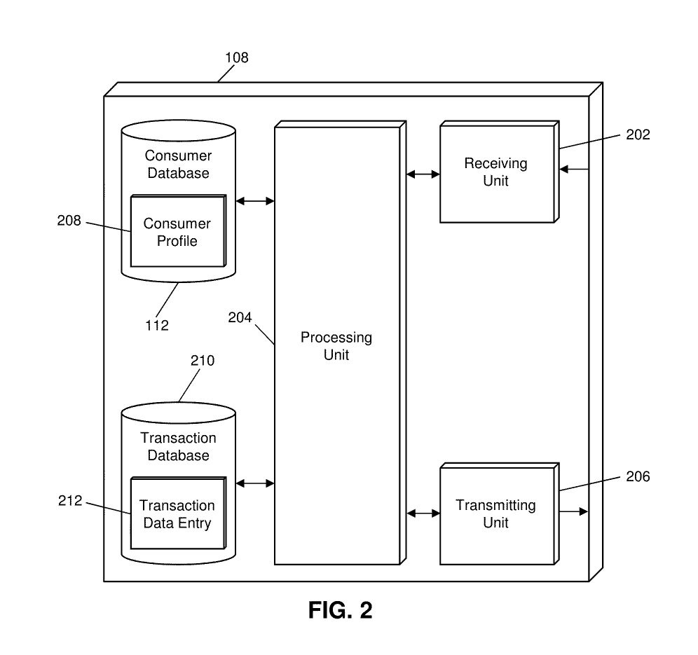

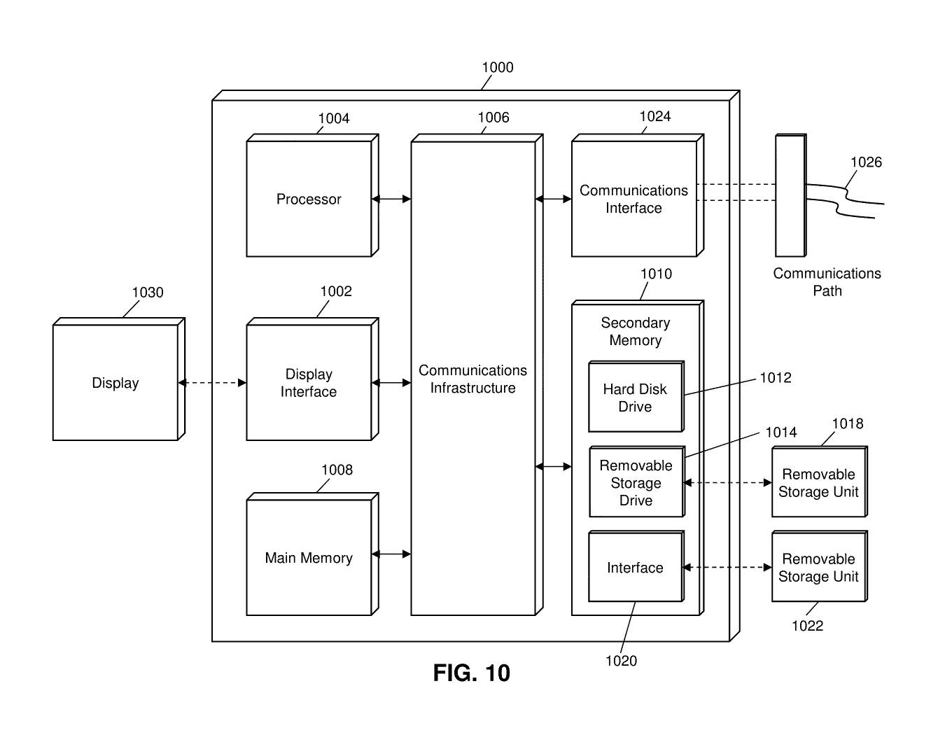

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 1000 illustrated in FIG. 10 and discussed in more detail below may be a suitable configuration of the processing server 108.

The processing server 108 may include a receiving unit 202. The receiving unit 202 may be configured to receive data over one or more networks via one or more network protocols. The receiving unit 202 may be configured to receive transaction data, demographic characteristic data, and phone data. The receiving unit 202 may be further configured to receive requests for consumer profiles and data (e.g., from the call center 118, the merchant 104, etc.).

The processing server 108 may also include a processing unit 204. The processing unit 204 may be configured to store received transaction data in a transaction database 210 as one or more transaction data entries 212. Each transaction data entry 212 may include data related to a corresponding payment transaction, such as a consumer identifier, merchant identifier, transaction amount, transaction time and/or date, geographic location, merchant name, product data, coupon or offer data, a point-of-sale identifier, or other suitable information as will be apparent to persons having skill in the relevant art. In some embodiments, each transaction data entry may also include demographic characteristics for a consumer (e.g., consumer characteristics) involved in the corresponding payment transaction.

The processing unit 204 may also be configured to store a plurality of consumer profiles 208 in the consumer database 112. Each consumer profile 208 may include data related to a consumer (e.g., the consumer 102), including at least a plurality of consumer characteristics. In some embodiments, each consumer profile 208 may also include a plurality of transaction data entries 212. In an exemplary embodiment, each consumer profile 208 may not include personally identifiable information unless expressly consented to by the corresponding consumer 102. In some embodiments, each consumer profile 208 may be associated with a specific set of consumer characteristics and may accordingly be related to a generic consumer of those characteristics rather than an actual consumer 102.

The processing unit 204 may be configured to link consumer profiles 208 with transaction data entries 212 based on demographic characteristics. The processing unit 204 may also be configured to link consumer profiles 208 including transaction data entries 212 with phone data received by the receiving unit 202. The processing unit 204 may be configured to link the consumer profiles 208 with the phone data via demographic characteristics included in the consumer profiles 208 and in the received phone data. In some instances, the processing unit 204 may match phone data to transaction history based on a predefined number of demographic characteristics (e.g., at least the predefined number of characteristics must match). In other instances, transaction history and phone data may be matched via algorithms or other systems and methods that will be apparent to persons having skill in the relevant art. In some embodiments, the processing unit 204 may store the received phone data in the linked consumer profile 208.

The processing server 108 may also include a transmitting unit 206. The transmitting unit 206 may be configured to transmit data over one or more networks via one or more network protocols. The transmitting unit 206 may be configured to transmit requests for data, such as to the demographic tracking agency 110 and/or the phone data provider 116. The transmitting unit 206 may also be configured to transmit transaction history and/or phone data, or a consumer profile 208 including linked transaction history and phone data, in response to a request from a third party (e.g., an advertiser, the merchant 104, the call center 118).

### Method for Linking Phone Data to Transaction History

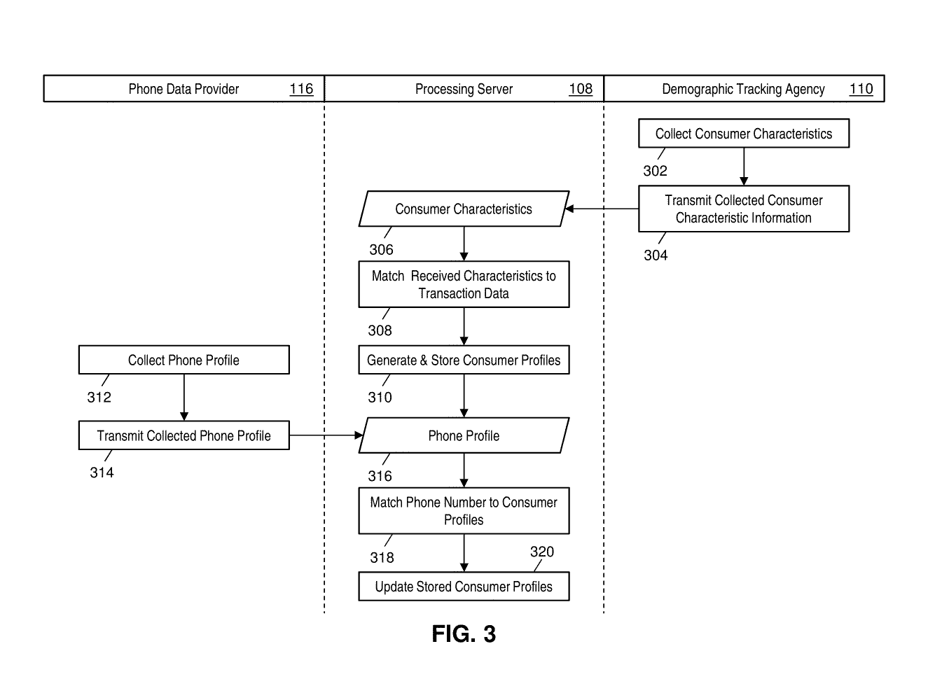

FIG. 3 illustrates a method for linking consumer phone data to transaction history.

In step 302, the demographic tracking agency 110 may collect demographic characteristics for one or more consumers. Methods and systems for collecting demographic characteristics will be apparent to persons having skill in the relevant art. The demographic tracking agency 110 may collect the information and may, in step 304, transmit the collected demographic characteristic information to the processing server 108.

In step 306, the processing server 108 may receive the demographic characteristic information. In step 308, the processing unit 204 of the processing server 108 may match the received demographic characteristic information to transaction data entries 212 included in the transaction database 210. In step 310, the processing unit 204 may generate consumer profiles 208 for matched transaction history and demographic characteristics (e.g., consumer characteristics) and store the consumer profiles 208 in the consumer database 112. In an exemplary embodiment, the processing unit 204 may bucket or otherwise modify the consumer characteristic information and/or transaction data to render the corresponding consumer profile 208 not personally identifiable. In some instances, the processing unit 204 may group transaction data entries 212 for multiple consumers sharing consumer characteristics into a single consumer profile 208.

In step 312, the phone data provider 116 may store phone profiles for one or more consumer phones 114 associated with consumers 102, the phone profiles including at least a phone number for the consumer phone 114 and a plurality of demographic characteristics that are associated with the corresponding consumer 102. In step 314, the phone data provider 116 may transmit the collected phone profile to the processing server 108. The processing server 108 may, in step 316, receive the phone profile from the phone data provider 116.

In step 318, the processing unit 204 of the processing server 108 may match the received phone number associated with the consumer phone 114 to the consumer profiles 208 based on matching of the demographic and consumer characteristics. In step 320, the processing server may update the consumer profiles 208 to include and/or be associated with the matched phone data.

### Method for Distributing a Consumer Profile

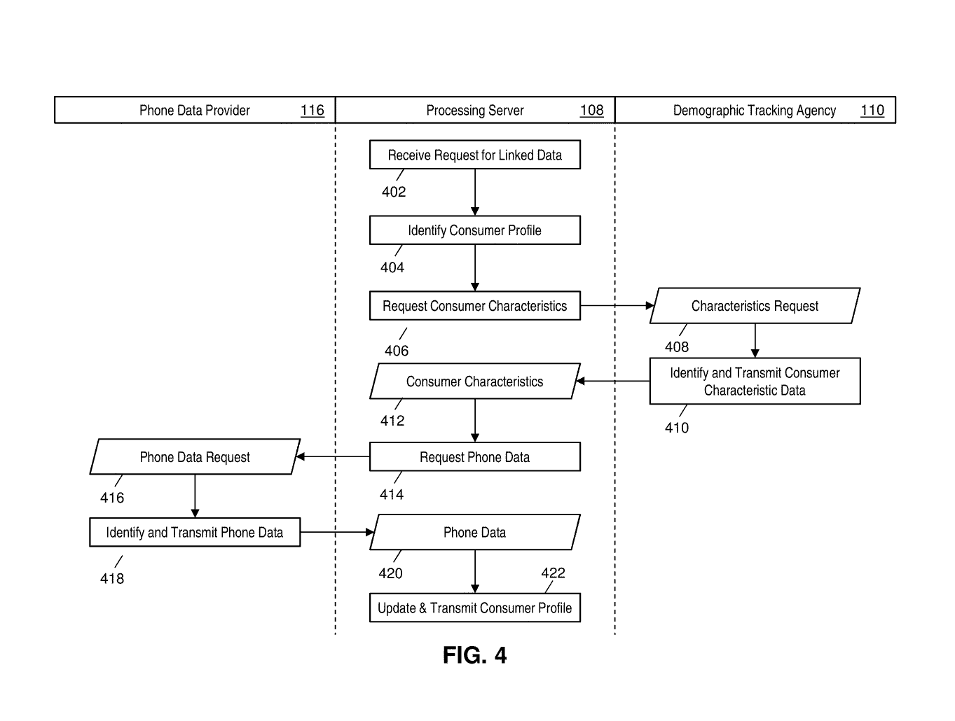

FIG. 4 illustrates a method for distributing a consumer profile including linked phone data and transaction history.

In step 402, the processing server 108 may receive (e.g., via the receiving unit 202) a request for linked consumer phone and transaction data. The request for linked data may include a consumer identifier or other identifying information, such as consumer characteristics. In step 404, the processing unit 204 within the processing server 108 may identify, in the consumer database 112, a consumer profile 208 based on the information included in the request.

In step 406, the processing server 108 may transmit (e.g., via the transmitting unit 206) to the demographic tracking agency 110, a request for consumer characteristics for the consumer associated with the identified consumer profile 208. In step 408, the demographic tracking agency 110 may receive the request, and, in step 410, may identify consumer characteristics associated with the consumer and transmit them back to the processing server 108. In step 412, the processing server 108 may receive the consumer characteristics associated with the consumer 102 related to the identified consumer profile 208.

In step 414, the processing server 108 may request at least a phone number for the consumer phone 114 associated with the consumer 102 from the phone data provider 116. The phone number request may include the previously received consumer characteristics. In step 416, the phone data provider 116 may receive the phone number request. In step 418, the phone data provider 116 may identify phone data associated with the consumer characteristics received in the phone number request and transmit phone data including at least the phone number associated with the consumer phone 114 to the processing server 108, which may receive the phone data in step 420.

In step 422, the processing server 108 may update the consumer profile 208 to include the received phone data, and may transmit the consumer profile 208 and/or the included transaction history and phone data as a response to the initially received request. In an exemplary embodiment, the consumer profile 208 may not include any personally identifiable information for the related consumer 102. In other embodiments, the processing server 108 may remove and/or render personally unidentifiable any personally identifiable information included in the consumer profile 208.

### Linking Phone Data to Transaction History

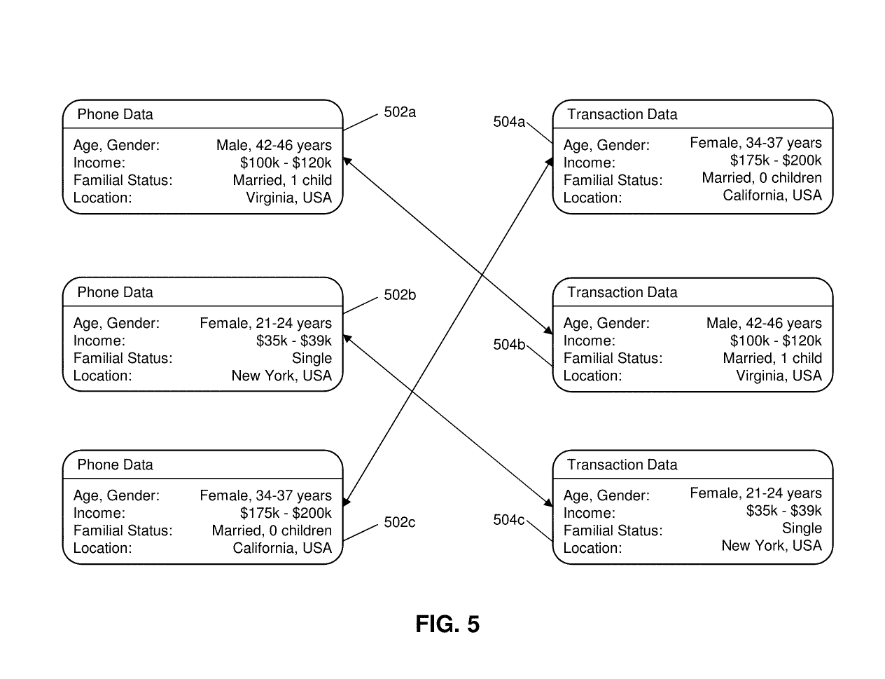

FIG. 5 illustrates the linking of consumer phone data 502 to transaction history 504 using demographic characteristics.

Each set of phone data 502, illustrated in FIG. 5 as phone data 502a, 502b, and 502c, may correspond to a consumer phone 114 associated with a consumer 102 and include a plurality of demographic characteristics associated with the respective consumer 102. For example, phone data 502a corresponds to a consumer 102 that is a male, of an age between 42 and 46 years old, has an income between $100,000 and $120,000, is married, has one child, and lives in Virginia. In some embodiments, the phone data 502a may correspond to a plurality of consumers each having the same demographic characteristics data.

Each set of transaction data 504, illustrated in FIG. 5 as transaction data 504a, 504b, and 504c, may correspond to a consumer 102 or a plurality of consumers 102, and include a plurality of consumer characteristics associated with the corresponding consumer or consumers 102. For example, transaction data 504a may correspond to a consumer 102 that is a female, of an age between 34 and 37 years old, has an income between $175,000 and $200,000, is married, has no children, and lives in California.

The processing unit 204 of the processing server 108 may identify the demographic characteristics for each of the phone data 502 and transaction data 504 and match the two sets of data based on common demographic and consumer characteristics. For example, as illustrated in FIG. 5, the processing unit 204 may match phone data 502a with transaction data 504b, phone data 502b with transaction data 504c, and phone data 502c with transaction data 504a. The processing unit 204 may then store the linked data in one or more consumer profiles 208 including the corresponding consumer characteristics.

In some embodiments, the demographic characteristics for the phone data 502 may not directly correspond to the consumer characteristics for the transaction data 504. In such an instance, the processing unit 204 may be configured to link the data based on a predefined number of matching characteristics. For example, if the transaction data 504b was associated with a consumer 102 having two children (instead of the one child illustrated in FIG. 5), while the phone data 502a is associated with a consumer 102 having only one child, the processing unit 204 may still link the two sets of data because the sets have at least five matching demographic characteristics including age, gender, income, marital status, and geographic location.

### Associating Phone, Transaction, and Demographic Data for Targeted Content Distribution

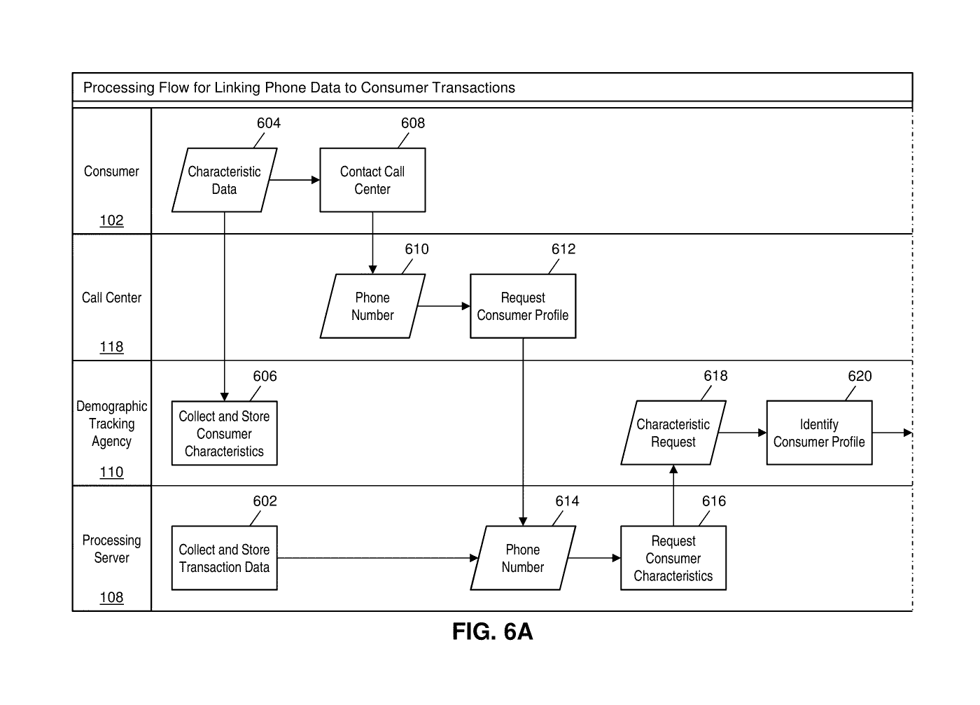

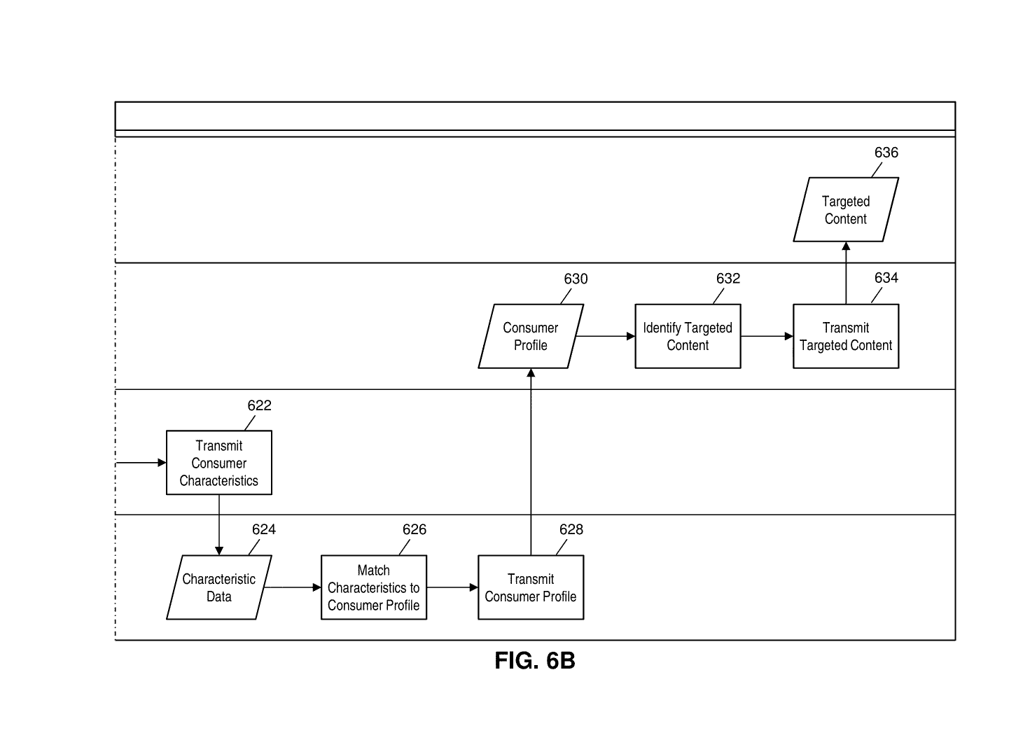

FIGS. 6A and 6B illustrate a method for the distribution of targeted content to a consumer 102 based on a consumer profile including transaction history, consumer characteristics, and a linked phone number generated and/or distributed using the methods and systems as discussed herein. It will be apparent to persons having skill in the relevant art that the distribution of targeted content based on a linked consumer profile is used as an illustration of a potential application of the systems and methods discussed herein only, and that there may be a variety of additional applications of linked transaction and phone data.

In step 602, the processing server 108 may collect transaction data from the payment network 106 and store the transaction data in a plurality of consumer profiles 208 in the consumer database 112. In step 604, the consumer 102 may transmit demographic characteristic data associated with themselves to the demographic tracking agency 110. The demographic characteristic data may include at least a phone number associated with the consumer 102 (e.g., corresponding to the consumer phone 114), and may further include age, gender, income, familial status, residential status, occupation, education, geographic location, or any other suitable data. In step 606, the demographic tracking agency 110 may receive the demographic characteristics associated with the consumer 102 and store them in a corresponding consumer profile.

In step 608, the consumer 102 may contact the call center 118 via the consumer phone 114. In an alternative embodiment, the call center 118 may contact the consumer 102 via the consumer phone 114. In step 610, the call center 118 may identify the phone number of the consumer phone 114 using methods and systems that will be apparent to persons having skill in the relevant art. In step 612, the call center 118 may request a consumer profile for the consumer 102 from the processing server 108 for use in identifying targeted content to distribute to the consumer 102. The request may include at least the identified phone number.

In step 614, the processing server 108 may receive (e.g., via the receiving unit 202) the phone number corresponding to the consumer phone 114 as part of the request for the consumer profile. In step 616, the processing server 108 may transmit (e.g., via the transmitting unit 206) a request for consumer characteristics to the demographic tracking agency 110, wherein the request includes at least the phone number of the consumer phone 114. In step 618, the demographic tracking agency 110 may receive the request, and then, in step 620, may identify a consumer profile including the phone number of the consumer phone 114.

In step 622, the demographic tracking agency 110 may transmit the consumer characteristics included in the identified consumer profile to the processing server 108. The processing server 108 may receive the consumer characteristics, in step 624. In some instances, the consumer characteristics may include all of those consumer characteristics provided by the consumer 102, may include only those consumer characteristics considered not personally identifiable to the consumer 102, or may include consumer characteristics specifically requested by the call center 118 and/or the processing server 108 (e.g., and communicated in the characteristics request).

In step 626, the processing unit 204 of the processing server 108 may match the received consumer characteristics to a consumer profile 208 stored in the consumer database 112 based on demographic characteristics stored in each consumer profile 208, such as illustrated in FIG. 5 and discussed above. In step 628, the transmitting unit 206 of the processing server 108 may transmit the matched consumer profile 208, including the consumer characteristics and transaction history, to the call center 118 in response to the earlier received request.

In step 630, the call center 118 may receive the requested consumer profile 208. Then, in step 632, the call center 118 may identify content targeted to the consumer 102 based on the data included in the consumer profile 208, including the consumer characteristics and the transaction data for the plurality of payment transactions involving a related consumer, which may be the consumer 102, a different consumer having the same or similar demographic characteristics, or a generic consumer having the same or similar demographic characteristics.

In step 634, the call center 118 may transmit the targeted content to the consumer 102, who may receive the targeted content, in step 636. The targeted content may be distributed via the consumer phone 114 (e.g., during a telephone call, via a short message service message, etc.) or any other suitable manner as will be apparent to persons having skill in the relevant art, such as e-mail, traditional mail, etc.

### Exemplary Method for Linking Phone Data to Transaction History

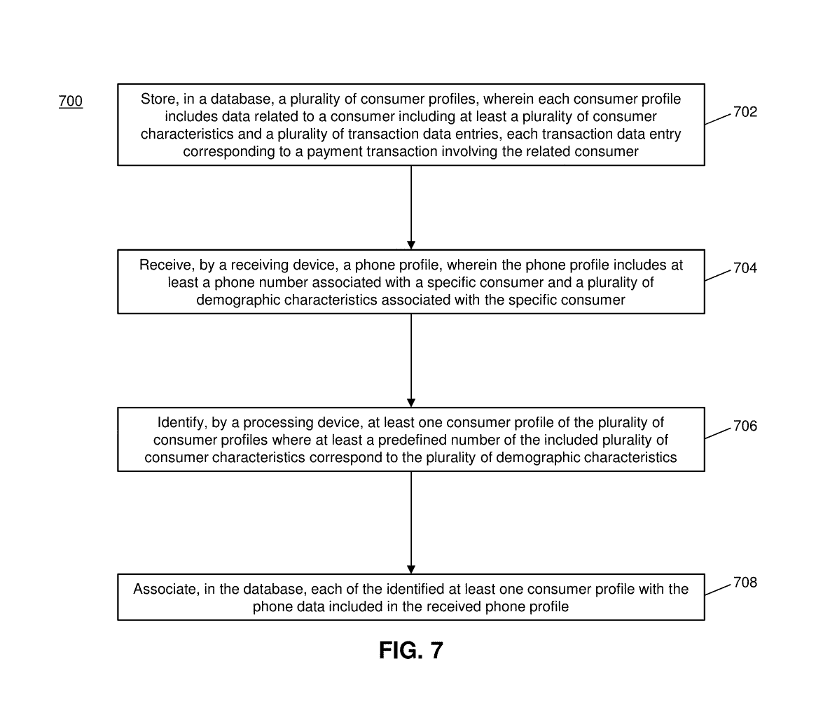

FIG. 7 illustrates a method 700 for linking consumer phone data to transaction history using demographic characteristics.

In step 702, a plurality of consumer profiles (e.g., the consumer profiles 208) may be stored in a database (e.g., the consumer database 112), wherein each consumer profile 208 includes data related to a consumer (e.g., the consumer 102) including at least a plurality of consumer characteristics and a plurality of transaction data entries (e.g., transaction data entries 212), each transaction data entry 212 corresponding to a payment transaction involving the related consumer 102. In some embodiments, the plurality of consumer characteristics may not be personally identifiable.

In one embodiment, the plurality of consumer characteristics may include at least one of: age, gender, income, marital status, familial status, residential status, occupation, education, zip code, postal code, street address, county, city, state, and country. In some embodiments, each transaction data entry 212 may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 704, a phone profile may be received, by a receiving device (e.g., the receiving unit 202), wherein the phone profile includes at least a phone number associated with a specific consumer 102 and a plurality of demographic characteristics associated with the specific consumer. In some embodiments, the plurality of demographic characteristics may not be personally identifiable.

In step 706, at least one consumer profile 208 of the plurality of consumer profiles may be identified, by a processing device (e.g., the processing unit 204), where at least a predefined number of the included plurality of consumer characteristics correspond to the plurality of demographic characteristics. In step 708, each of the identified at least one consumer profiles 208 may be associated, in the consumer database 112, with the phone number included in the received phone profile. In one embodiment, the method 700 may further include transmitting, by a transmitting device (e.g., the transmitting unit 206), one of the identified at least one consumer profile 208.

### Exemplary Method for Distributing a Linked Consumer Profile

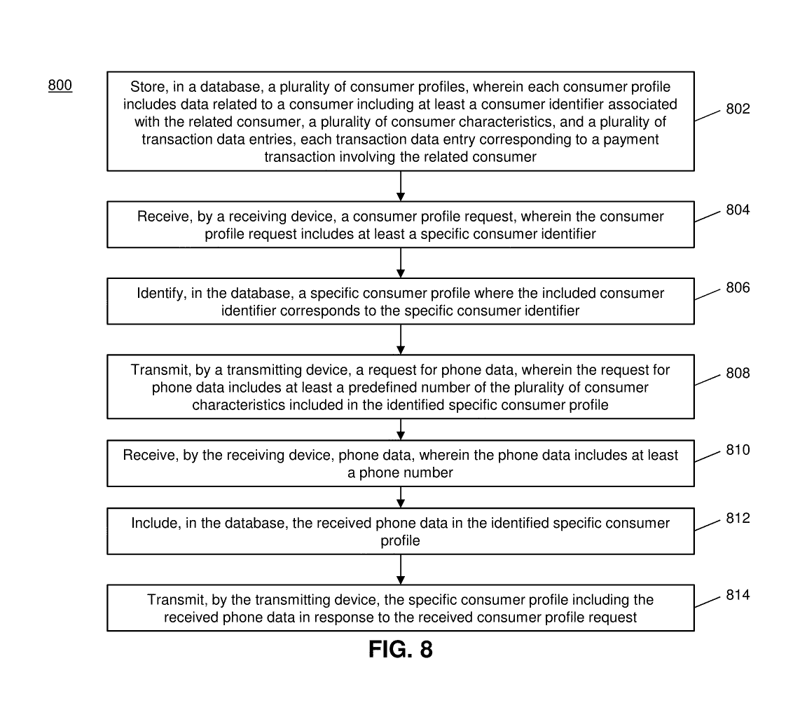

FIG. 8 illustrates a method 800 for distributing a consumer profile including phone data and transaction history linked based on demographic characteristics.

In step 802, a plurality of consumer profiles (e.g., the consumer profiles 208) may be stored, in a database (e.g., the consumer database 112), wherein each consumer profile 208 includes data related to a consumer (e.g., the consumer 102), including at least a consumer identifier associated with the related consumer 102, a plurality of consumer characteristics, and a plurality of transaction data entries (e.g., transaction data entries 212), each transaction data entry 212 corresponding to a payment transaction involving the related consumer 102. In some embodiments, the plurality of demographic characteristics may not be personally identifiable.

In one embodiment, the plurality of consumer demographic characteristics may include at least one of: age, gender, income, marital status, familial status, residential status, occupation, education, zip code, postal code, street address, county, city, state, and country. In some embodiments, each transaction data entry 212 may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 804, a consumer profile request may be received, by a receiving device (e.g., the receiving unit 202), wherein the consumer profile request includes at least a specific consumer identifier. In step 806, a specific consumer profile 208 may be identified, in the consumer database 112, where the included consumer identifier corresponds to the specific consumer identifier. In step 808, a request for phone data may be transmitted, by a transmitting device (e.g., the transmitting unit 206), wherein the request for phone data includes at least the plurality of consumer characteristics included in the identified specific consumer profile 208.

In step 810, the receiving device 202 may receive phone data, wherein the phone data includes at least a phone number. In one embodiment, the request for phone data may further include a predefined number, the received phone data may be associated with demographic characteristics, and a number of the plurality of consumer characteristics included in the specific consumer profile 208 that correspond to the plurality of demographic characteristics is at least the predefined number. In a further embodiment, the plurality of demographic characteristics may not be personally identifiable.

In step 812, the received phone data may be included, in the consumer database 112, in the identified specific consumer profile 208. In step 814, the specific consumer profile 208 including the received phone data may be transmitted, by the transmitting device 206, in response to the received consumer profile request.

### Exemplary Method for Linking Phone Data to Demographic Data and Transaction History

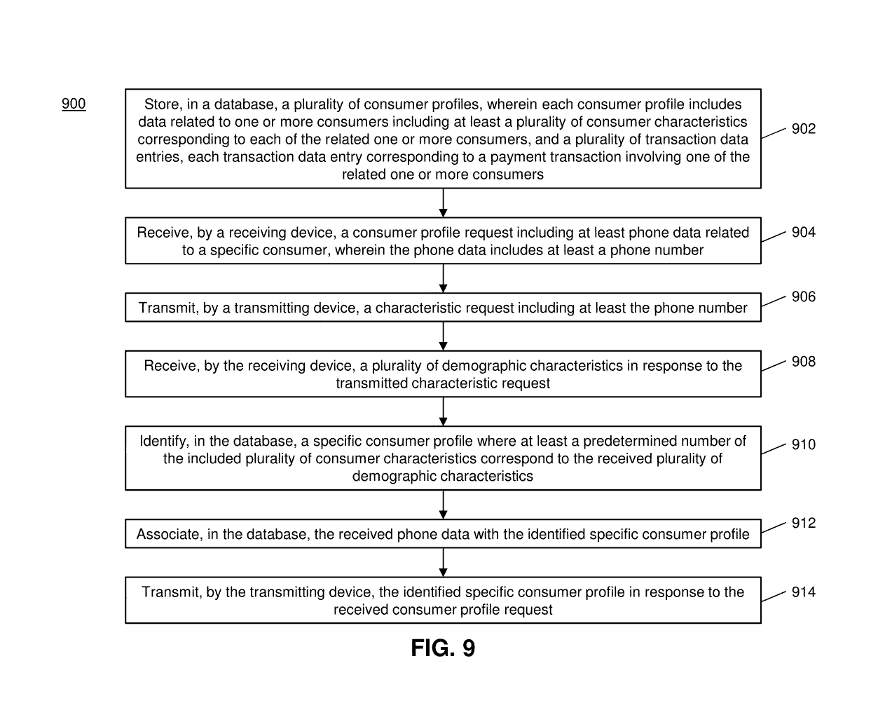

FIG. 9 illustrates a method 900 for linking phone data to demographic characteristics and transaction history.

In step 902, a plurality of consumer profiles (e.g., the consumer profiles 208) may be stored, in a database (e.g., the consumer database 112), wherein each consumer profile 208 includes data related to one or more consumers (e.g., consumers 102) including at least a plurality of consumer characteristics corresponding to each of the related one or more consumers 102, and a plurality of transaction data entries, each transaction data entry corresponding to a payment transaction involving one of the related one or more consumers 102. In one embodiment, the plurality of consumer characteristics may include at least one of: age, gender, income, marital status, familial status, residential status, occupation, education, zip code, postal code, street address, county, city, state, and country. In some embodiments, the plurality of consumer characteristics may not be personally identifiable.

In one embodiment, each transaction data entry may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 904, a consumer profile request may be received, by a receiving device (e.g., the receiving unit 202), wherein the request includes at least phone data related to a specific consumer 102, the phone data including at least a phone number. In step 906, a characteristic request may be transmitted, by a transmitting device (e.g., the transmitting unit 206), wherein the characteristic request includes at least the phone number.

In step 908, a plurality of demographic characteristics may be received, by the receiving device 202, in response to the transmitted characteristic request. In some embodiments, the plurality of demographic characteristics may not be personally identifiable. In step 910, a specific consumer profile 208 may be identified, in the consumer database 112, where at least a predetermined number of the included plurality of consumer characteristics correspond to the received plurality of demographic characteristics.

In step 912, the received phone data may be associated, in the consumer database 112, with the identified specific consumer profile 208. In step 914, the identified specific consumer profile 208 may be transmitted, by the transmitting device 206, in response to the received consumer profile request.

### Computer System Architecture

FIG. 10 illustrates a computer system 1000 in which embodiments of the present disclosure, or portions thereof, may be implemented as computer-readable code. For example, the processing server 108 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, 6A, 6B, and 7-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. The processor device 1004 may be connected to a communications infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive or universal serial bus port, the removable storage unit 1018 may be a floppy disk or portable flash drive, respectively. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

The computer system 1000 may further include a display interface 1002. The display interface 1002 may be configured to allow data to be transferred between the computer system 1000 and external display 1030. Exemplary display interfaces 1002 may include high-definition multimedia interface (HDMI), digital visual interface (DVI), video graphics array (VGA), etc. The display 1030 may be any suitable type of display for displaying data transmitted via the display interface 1002 of the computer system 1000, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1008 and secondary memory 1010, which may be memory semiconductors (e.g., DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 3, 4, 6A, 6B, and 7-9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for linking phone data to transaction history and distributing linked consumer profiles. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for linking phone data to transaction history, comprising:
storing, in a database, a plurality of consumer profiles, wherein each consumer profile includes data related to a consumer including at least a plurality of consumer characteristics and a plurality of transaction data entries, each transaction data entry corresponding to a payment transaction involving the related consumer;
receiving, by a receiving device, a phone profile, wherein the phone profile includes at least a phone number associated with a specific consumer and a plurality of demographic characteristics associated with the specific consumer;
identifying, by a processing device, at least one consumer profile of the plurality of consumer profiles where at least a predefined number of the included plurality of consumer characteristics correspond to the plurality of demographic characteristics; and
associating, in the database, each of the identified at least one consumer profile with the phone number included in the received phone profile.

2. The method of claim 1, wherein the plurality of consumer characteristics includes at least one of: age, gender, income, marital status, familial status, residential status, occupation, education, zip code, postal code, street address, county, city, state, and country.

3. The method of claim 1, wherein each transaction data entry includes at least transaction data, a consumer identifier associated with the related consumer, and a merchant identifier associated with a merchant involved in the corresponding payment transaction.

4. The method of claim 3, wherein the transaction data includes at least one of: a transaction amount, product data, transaction time and/or date, geographic location, coupon data, and point-of-sale identifier.

5. The method of claim 1, wherein the plurality of consumer characteristics are not personally identifiable.

6. The method of claim 1, wherein the plurality of demographic characteristics are not personally identifiable.

7. The method of claim 1, further comprising:
transmitting, by a transmitting device, one of the identified at least one consumer profile.

8. A method for distributing a linked consumer profile, comprising:
storing, in a database, a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer;
receiving, by a receiving device, a consumer profile request, wherein the consumer profile request includes at least a specific consumer identifier;
identifying, in the database, a specific consumer profile where the included consumer identifier corresponds to the specific consumer identifier;
transmitting, by a transmitting device, a request for phone data, wherein the request for phone data includes at least a predefined number of the plurality of consumer characteristics included in the identified specific consumer profile;
receiving, by the receiving device, phone data, wherein the phone data includes at least a phone number;
including, in the database, the received phone data in the identified specific consumer profile; and
transmitting, by the transmitting device, the specific consumer profile including the received phone data in response to the received consumer profile request.

9. The method of claim 8, wherein the phone data is associated with a plurality of demographic characteristics, and at least the predefined number of the plurality of consumer characteristics included in the specific consumer profile correspond to the plurality of demographic characteristics.

10. The method of claim 8, wherein the plurality of consumer characteristics includes at least one of: age, gender, income, marital status, familial status, residential status, occupation, education, zip code, postal code, street address, county, city, state, and country.

11. The method of claim 8, wherein each transaction data entry includes at least transaction data, a consumer identifier associated with the related consumer, and a merchant identifier associated with a merchant involved in the corresponding payment transaction.

12. The method of claim 11, wherein the transaction data includes at least one of: a transaction amount, product data, transaction time and/or date, geographic location, coupon data, and point-of-sale identifier.

13. The method of claim 8, wherein the plurality of consumer characteristics are not personally identifiable.

14. The method of claim 8, wherein the plurality of demographic characteristics are not personally identifiable.

15. A method for linking phone data to transaction history, comprising:
storing, in a database, a plurality of consumer profiles, wherein each consumer profile includes data related to one or more consumers including at least a plurality of consumer characteristics corresponding to each of the related one or more consumers, and a plurality of transaction data entries, each transaction data entry corresponding to a payment transaction involving one of the related one or more consumers;
receiving, by a receiving device, a consumer profile request including at least phone data related to a specific consumer, wherein the phone data includes at least a phone number;
transmitting, by a transmitting device, a characteristic request including at least the phone number;
receiving, by the receiving device, a plurality of demographic characteristics in response to the transmitted characteristic request;
identifying, in the database, a specific consumer profile where at least a predetermined number of the included plurality of consumer characteristics correspond to the received plurality of demographic characteristics;
associating, in the database, the received phone data with the identified specific consumer profile; and
transmitting, by the transmitting device, the identified specific consumer profile in response to the received consumer profile request.

16. The method of claim 15, wherein the plurality of consumer characteristics includes at least one of: age, gender, income, marital status, familial status, residential status, occupation, education, zip code, postal code, street address, county, city, state, and country.

17. The method of claim 15, wherein each transaction data entry includes at least transaction data, a consumer identifier associated with the related consumer, and a merchant identifier associated with a merchant involved in the corresponding payment transaction.

18. The method of claim 17, wherein the transaction data includes at least one of: a transaction amount, product data, transaction time and/or date, geographic location, coupon data, and point-of-sale identifier.

19. The method of claim 15, wherein the plurality of consumer characteristics are not personally identifiable.

20. The method of claim 15, wherein the plurality of demographic characteristics are not personally identifiable.

21. A system for linking phone data to transaction history, comprising:
a database configured to store a plurality of consumer profiles, wherein each consumer profile includes data related to a consumer including at least a plurality of consumer characteristics and a plurality of transaction data entries, each transaction data entry corresponding to a payment transaction involving the related consumer;
a receiving device configured to receive a phone profile, wherein the phone profile includes at least a phone number associated with a specific consumer and a plurality of demographic characteristics associated with the specific consumer; and
a processing device configured to
identify at least one consumer profile of the plurality of consumer profiles where at least a predefined number of the included plurality of consumer characteristics correspond to the plurality of demographic characteristics, and
associate, in the database, each of the identified at least one consumer profile with the phone data included in the received phone profile.

22. The system of claim 21, wherein the plurality of consumer characteristics includes at least one of: age, gender, income, marital status, familial status, residential status, occupation, education, zip code, postal code, street address, county, city, state, and country.

23. The system of claim 21, wherein each transaction data entry includes at least transaction data, a consumer identifier associated with the related consumer, and a merchant identifier associated with a merchant involved in the corresponding payment transaction.

24. The system of claim 23, wherein the transaction data includes at least one of: a transaction amount, product data, transaction time and/or date, geographic location, coupon data, and point-of-sale identifier.

25. The system of claim 21, wherein the plurality of consumer characteristics are not personally identifiable.

26. The system of claim 21, wherein the plurality of demographic characteristics are not personally identifiable.

27. A system for distributing a linked consumer profile, comprising:
a database configured to store a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer;
a receiving device configured to receive a consumer profile request, wherein the consumer profile request includes at least a specific consumer identifier;
a processing device configured to identify, in the database, a specific consumer profile where the included consumer identifier corresponds to the specific consumer identifier; and
a transmitting device configured to transmit a request for phone data, wherein the request for phone data includes at least a predefined the plurality of consumer characteristics included in the identified specific consumer profile, wherein
the receiving device is further configured to receive phone data, wherein the phone data includes at least a phone number,
the processing device is further configured to include, in the database, the received phone data in the identified specific consumer profile, and
the transmitting device is further configured to transmit the specific consumer profile including the received phone data in response to the received phone data request.

28. The system of claim 27, wherein the phone data is associated with a plurality of demographic characteristics, and at least the predefined number of the plurality of consumer characteristics included in the specific consumer profile correspond to the plurality of demographic characteristics.

29. The system of claim 27, wherein the plurality of consumer characteristics includes at least one of: age, gender, income, marital status, familial status, residential status, occupation, education, zip code, postal code, street address, county, city, state, and country.

30. The system of claim 27, wherein each transaction data entry includes at least transaction data, a consumer identifier associated with the related consumer, and a merchant identifier associated with a merchant involved in the corresponding payment transaction.

31. The system of claim 30, wherein the transaction data includes at least one of: a transaction amount, product data, transaction time and/or date, geographic location, coupon data, and point-of-sale identifier.

32. The system of claim 27, wherein the plurality of consumer characteristics are not personally identifiable.

33. The system of claim 27, wherein the plurality of demographic characteristics are not personally identifiable.

34. A system for linking phone data to transaction history, comprising:
a processing device;
a database configured to store a plurality of consumer profiles, wherein each consumer profile includes data related to one or more consumers including at least a plurality of consumer characteristics corresponding to each of the related one or more consumers, and a plurality of transaction data entries, each transaction data entry corresponding to a payment transaction involving one of the related one or more consumers;
a receiving device configured to receive a consumer profile request including at least phone data related to a specific consumer, wherein the phone data includes at least a phone number; and
a transmitting device configured to transmit a characteristic request including at least the phone number, wherein
the receiving device is further configured to receive a plurality of demographic characteristics in response to the transmitted characteristic request,
the processing device is configured to
identify, in the database, a specific consumer profile where at least a predetermined number of the included plurality of consumer characteristics correspond to the received plurality of demographic characteristics, and
associate, in the database, the received phone data with the identified specific consumer profile, and
the transmitting device is further configured to transmit the identified specific consumer profile in response to the received consumer profile request.

35. The system of claim 34, wherein the plurality of consumer characteristics includes at least one of: age, gender, income, marital status, familial status, residential status, occupation, education, zip code, postal code, street address, county, city, state, and country.

36. The system of claim 34, wherein each transaction data entry includes at least transaction data, a consumer identifier associated with the related consumer, and a merchant identifier associated with a merchant involved in the corresponding payment transaction.

37. The system of claim 36, wherein the transaction data includes at least one of: a transaction amount, product data, transaction time and/or date, geographic location, coupon data, and point-of-sale identifier.

38. The system of claim 34, wherein the plurality of consumer characteristics are not personally identifiable.

39. The system of claim 34, wherein the plurality of demographic characteristics are not personally identifiable.
